(19) United States
(12) Patent Application Publication
(10) Pub. No.: US 2026/0123589 A1
(43) Pub. Date: May 7, 2026

(54) IRRIGATION DEVICE, IRRIGATION CONTROL SYSTEM, AND CONTROL METHOD THEREOF

(71) Applicant: ZhongShan Qing Yi Metal Products Enterprise CO., LTD, ZhongShan City (CN)

(72) Inventors: Shulong Li, ZhongShan City (CN); Tang Chieh Yu, Taichung City (TW); JiZhong Wang, ZhongShan City (CN); Kunguang Wu, ZhongShan City (CN)

(21) Appl. No.: 19/376,993

(22) Filed: Nov. 2, 2025

(30) Foreign Application Priority Data
Nov. 6, 2024 (CN) 2024115741005

(51) Int. Cl. A01G 25/16

(52) U.S. Cl. CPC A01G 25/165

(57) ABSTRACT

An irrigation device, an irrigation control system, and a control method thereof are disclosed. The irrigation device includes a first housing, a wireless control module, and a valve unit. The first housing defines therein a main flow passage and a branch flow passage that are in mutual communication. The first housing is provided with an inlet port and a first outlet port that correspond to an upstream end and a downstream end of the main flow passage, respectively, and is provided with a second outlet port communicated with a downstream end of the branch flow passage. The valve unit is partially located in the branch flow passage and is connected to the first wireless control module so that the first wireless control module controls the valve unit to open or close the branch flow passage.

### BACKGROUND OF THE INVENTION

### 1. Technical Field

The present invention relates to the technical field of smart Internet of Things (IoT) technologies, and more particularly to an irrigation device, an irrigation control system, and a control method thereof.

### 2. Description of Related Art

Existing smart irrigation devices are connected to a water supply source through water tubes and are further connected with components such as sprinklers. A user can wirelessly control the irrigation devices via a smart terminal so as to activate or deactivate the irrigation devices. However, each irrigation device is independently connected to the water supply source through a respective water tube. When multiple irrigation locations are required, the number of connection ports of the water supply source may be insufficient. In addition, when all irrigation devices are activated simultaneously, the water pressure supplied by the water source to each irrigation device is reduced, and variations in water pressure affect the spraying range of the sprinklers, thereby resulting in unsatisfactory irrigation performance.

### SUMMARY OF THE INVENTION

The present invention is intended to at least address one of the technical problems existing in the prior art. To this end, the present invention provides an irrigation device, an irrigation control system, and a control method thereof, which are characterized by an easy, simple layout and rational, orderly control, thereby ensuring desired irrigation quality.

According to one embodiment of a first aspect of the present invention, an irrigation device comprises:
a first housing, defining a main flow passage and a branch flow passage therein, the first housing being provided with an inlet port, a first outlet port, and a second outlet port, the inlet port being in fluid communication with an upstream end of the main flow passage, the first outlet port being in fluid communication with a downstream end of the main flow passage, the branch flow passage having an upstream end being in fluid communication with the main flow passage, and the second outlet port being in fluid communication with a downstream end of the branch flow passage;
a first wireless control module, disposed in the first housing; and
a valve unit, disposed in the first housing and partially located in the branch flow passage, wherein the first wireless control module is connected to and controls the valve unit to open or close the branch flow passage.

According to the embodiment of the present invention, the irrigation device has at least the following beneficial effects:
The irrigation device of the present invention defines the main flow passage therein, and plural irrigation devices may be interconnected through a water tube, with the first outlet port of an upstream irrigation device in fluid communication with the inlet port of a downstream irrigation device through the water tube, thereby forming the irrigation string assembly. The inlet port of the upstream-most irrigation device in the irrigation string assembly may be connected to a water source via the water tube so that water can flow along and through the main flow passage. A user then can use a smart terminal to send a wireless control signal that causes any one or more irrigation devices to open the respective valve unit(s), thereby opening the branch flow passage(s). The second outlet port of each irrigation device is configured to connect a sprinkler component, and the water flowing in can be dispensed through the sprinkler component for irrigation. The user may adjust the number of open irrigation devices based on the water pressure. This design features easy, simple layout and rational, orderly control, thereby ensuring desired irrigation quality.

According to one embodiment of the second aspect of the present invention, an irrigation control system comprises a gateway unit and a plurality of irrigation devices as described in the previous embodiment, wherein the gateway unit is in wireless connection with the irrigation devices, respectively, and the irrigation devices are connected in series by a water tube to form at least a part of an irrigation string assembly, so that in the irrigation string assembly, between two adjacent said irrigation devices, the first outlet port of the upstream irrigation device is in fluid communication with the inlet port of the downstream irrigation device through the water tube.

According to the embodiment of the present invention, the irrigation control system has at least the following beneficial effects:
The irrigation control system employs the irrigation devices disclosed in any of the foregoing embodiments. The first outlet port of an upstream irrigation device is in fluid communication with the inlet port of a downstream irrigation device through the water tube, thereby forming an irrigation string assembly. The inlet port of the upstream-most irrigation device in the irrigation string assembly may be connected to a water source via the water tube so that water can flow along and through the main flow passage. A user then can use a smart terminal to send a wireless control signal that causes any one or more irrigation devices to open the respective valve unit(s), thereby opening the branch flow passage(s). The second outlet port of each irrigation device is configured to connect a sprinkler component, and the water flowing in can be dispensed through the sprinkler component for irrigation. The user may adjust the number of open irrigation devices based on the water pressure. This design features easy, simple layout and rational, orderly control, thereby ensuring desired irrigation quality.

According to an embodiment of the third aspect of the present invention, a control method is applicable to an irrigation control system as described in the previous embodiment. The control method comprises: network-binding the gateway unit with each of the irrigation devices in the irrigation string assembly so as to form at least a part of an irrigation network assembly; connecting and communicating with the gateway unit to acquire identity information of the gateway unit and the irrigation devices in the irrigation network assembly;
acquiring a first control instruction, and establishing irrigation program data corresponding to the irrigation network assembly in accordance with the first control instruction, wherein the irrigation program data include irrigation durations for the individual irrigation devices and an irrigation sequence among the irrigation devices; and distributing the irrigation program data to the corresponding gateway unit, and entering the irrigation network assembly into a first irrigation mode, in which the irrigation devices in the irrigation network assembly open the branch flow passages thereof sequentially according to the irrigation sequence and close the branch flow passages when their corresponding irrigation durations elapse.

According to the embodiment of the present invention, the control method has at least the following beneficial effects:
According to the control method of the present invention, the gateway unit and the respective irrigation devices in the corresponding irrigation string assembly are network-bound to form an irrigation network assembly. A user can communicate with the gateway unit through a smart terminal to control each irrigation device network-bound with the gateway unit. Since identity information of each irrigation device is acquired, the user can, through a first control instruction, formulate irrigation program data corresponding to the irrigation network assembly for each irrigation device, so as to control the irrigation devices in the irrigation network assembly to sequentially open the branch flow passages according to the irrigation sequence. Each irrigation device closes its branch flow passage when its respective irrigation duration elapses. By sequentially opening the branch flow passages of the irrigation devices, a stable water pressure supply across different irrigation positions is ensured, and each irrigation device is opened during its corresponding irrigation duration to supply water to its associated sprinkler component. This design features easy, simple layout and rational, orderly control, thereby ensuring desired irrigation quality.

### BRIEF DESCRIPTION OF THE DRAWINGS

FIG. 1 shows perspective views of the irrigation device and the gateway unit according to one embodiment of the present invention;

FIG. 2 is an exploded view of the irrigation device according to one embodiment of the present invention;

FIG. 3 is a block diagram illustrating the principle and structure of the irrigation control system according to one embodiment of the present invention;

FIG. 4 is a schematic drawing of the irrigation string assembly according to one embodiment of the present invention;

FIG. 5 is a first flowchart of the control method according to one embodiment of the present invention; and

FIG. 6 is a second flowchart of the control method according to one embodiment of the present invention.

### DETAILED DESCRIPTION OF THE INVENTION

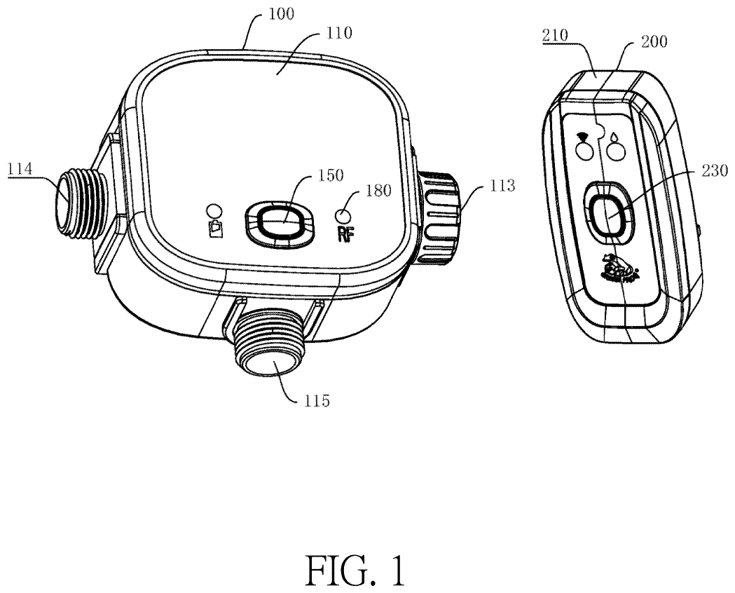

As shown in FIG. 1 through FIG. 4, an irrigation device 100 according to one embodiment of the first aspect of the present invention comprises a first housing 110, a first wireless control module 120, and a valve unit 130. The first housing 110 defines a main flow passage and a branch flow passage therein. The first housing 100 is provided with an inlet port 113, a first outlet port 114, and a second outlet port 115. The inlet port 113 is in fluid communication with the upstream end of the main flow passage 111. The first outlet port 114 is in fluid communication with the downstream end of the main flow passage 111. The upstream end of the branch flow passage 112 is in fluid communication with the main flow passage 111. The second outlet port 115 is in fluid communication with the downstream end of the branch flow passage 112. The first wireless control module 120 is disposed in the first housing 110. The valve unit 130 is disposed in the first housing 110, and a part of the valve unit 130 is located in the branch flow passage 112. The first wireless control module 120 is connected to and controls the valve unit 130 to open or close the branch flow passage 112.

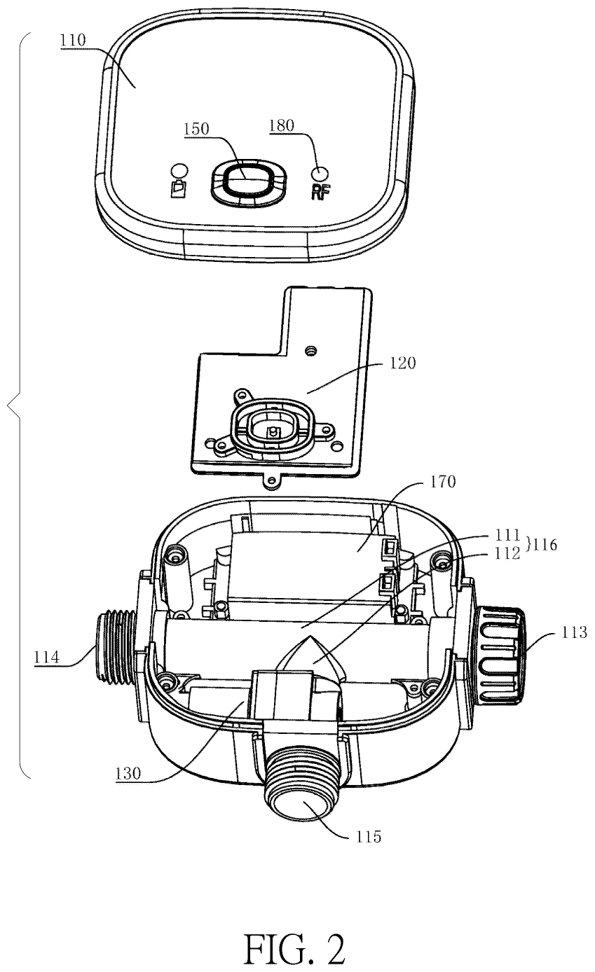

As shown in FIG. 1 and FIG. 2, in the first housing 110, a piping 116 forms the main flow passage 111 and the branch flow passage 112. The valve unit 130 may be implemented by a regular solenoid valve. The valve unit 130 partially extends into the branch flow passage 112. The valve unit 130 is configured to operate to open or close the branch flow passage 112, thereby controlling the discharge of water from the second outlet port 115. The first wireless control module 120 comprises a first control module and a first wireless communication module. Therein, the first control module may be implemented by an MCU or a CPU together with peripheral circuits thereof, and the first wireless communication module may be implemented by a Bluetooth chip, a Wi-Fi chip, an RF chip, or corresponding peripheral circuits thereof. A power supply component 170, such as a rechargeable battery, is further disposed in the first housing 110. The power supply component 170 is electrically connected to the first wireless control module 120 and the valve unit 130 to provide power thereto. A first button 150 may also be disposed on a surface of the first housing 110. The first button 150 is electrically connected to the first wireless control module 120. When the first button 150 is operated by a user, a wireless network configuration mode of the irrigation device 100 is enabled or disabled. In the wireless network configuration mode, the irrigation device 100 sends a network configuration request.

The irrigation device 100 of the present invention defines the main flow passage 111 therein, and plural irrigation devices 100 may be interconnected through a water tube, with the first outlet port 114 of the upstream irrigation device 100 in fluid communication with the inlet port 113 of the downstream irrigation device 100 through the water tube, thereby forming the irrigation string assembly 160. The inlet port 113 of the upstream-most irrigation device 100 in the irrigation string assembly 160 may be connected to a water source via the water tube so that water can flow along and through the main flow passage 111. A user then can use a smart terminal 300 to send a wireless control signal that causes any one or more irrigation devices 100 to open the respective valve unit(s) 130, thereby opening the branch flow passage(s) 112. The second outlet port 115 of each irrigation device 100 is configured to connect a sprinkler component, and the water flowing in can be dispensed through the sprinkler component for irrigation. The user may adjust the number of open irrigation devices 100 based on the water pressure. This design features easy, simple layout and rational, orderly control, thereby ensuring desired irrigation quality.

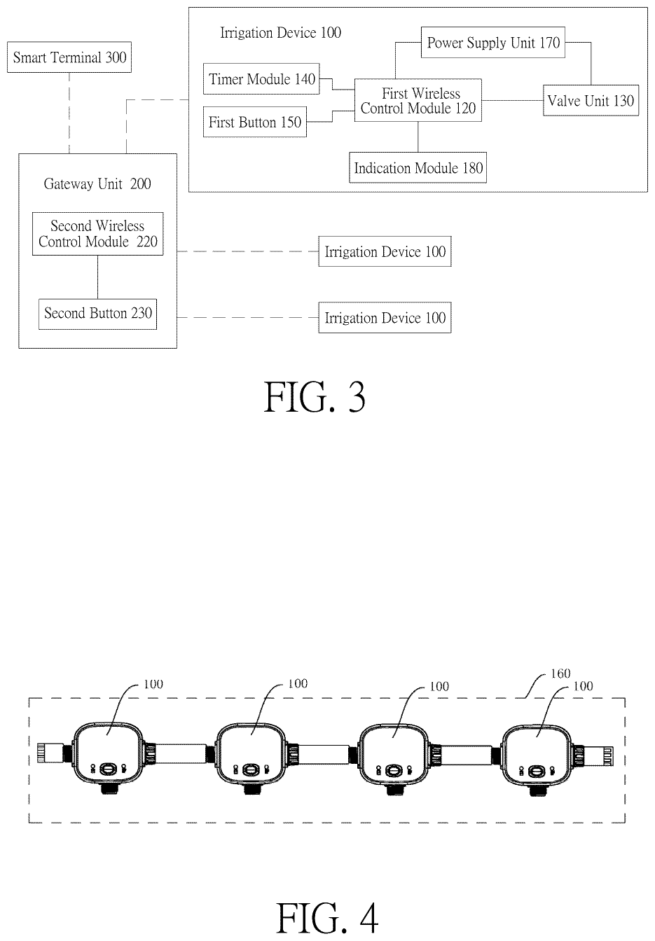

In some embodiments of the present invention, as shown in FIG. 3, the irrigation device 100 further comprises a timer module 140. The timer module 140 is connected to the first wireless control module 120 and is configured to provide timing signals. The first wireless control module 120 controls the valve unit 130 to open or close the branch flow passage 112 according to the timing signals.

The timer module 140 may be implemented by a regular timer component, or by a timer program loaded in the first wireless control module 120. The timer module 140 provides the timing signals. Each irrigation device 100 may be programmed with a default irrigation duration, such as five minutes or ten minutes. The irrigation device 100 may also receive, via a wireless signal, a time-setting instruction to set its irrigation duration. Timing starts when the branch flow passage 112 of the irrigation device 100 is open, and when the timing signal reaches the irrigation duration, the branch flow passage 112 is controlled to be closed.

According to an embodiment of a second aspect of the present invention, an irrigation control system comprises a gateway unit 200 and plural irrigation devices 100 as disclosed in any of the foregoing embodiments. The gateway unit 200 is wirelessly connected to each of the irrigation devices 100. The irrigation devices 100 are connected in series by a water tube to form at least a part of an irrigation string assembly 160. Therein, between two adjacent irrigation devices 100 in the irrigation string assembly 160, the first outlet port 114 of the upstream irrigation device is in fluid communication with the inlet port 113 of the downstream irrigation device 100 through the water tube.

The irrigation control system of the present invention employs the irrigation devices 100 disclosed in any of the foregoing embodiments. The first outlet port 114 of an upstream irrigation device 100 is in fluid communication with the inlet port 113 of a downstream irrigation device 100 through the water tube, thereby forming an irrigation string assembly 160. The inlet port 113 of the upstream-most irrigation device 100 in the irrigation string assembly may be connected to a water source via the water tube so that water can flow along and through the main flow passage 111. A user then can use a smart terminal 300 to send a wireless control signal that causes any one or more irrigation devices 100 to open the respective valve unit(s) 130, thereby opening the branch flow passage(s) 112. The second outlet port 115 of each irrigation device 100 is configured to connect a sprinkler component, and the water flowing in can be dispensed through the sprinkler component for irrigation. The user may adjust the number of open irrigation devices 100 based on the water pressure. This design features easy, simple layout and rational, orderly control, thereby ensuring desired irrigation quality.

The gateway unit 200 may function as a repeater connecting a part of the irrigation devices 100. Some of the irrigation devices 100 may also be connected in sequence to form at least a part of the irrigation string assembly 160. The gateway unit 200 and a part of the irrigation devices 100 form a network. Both the smart terminal 300 and the cloud platform can establish wireless communication connections with the irrigation devices 100 in the network via the gateway unit 200. Control instructions issued from the smart terminal 300 and the cloud platform are transmitted to the gateway unit 200, which in turn forwards the control instructions to the respective irrigation devices 100 in the network.

In some embodiments of the present invention, the gateway unit 200 comprises a second housing 210 and a second wireless control module 220 disposed in the second housing 210. The second wireless control module 220 is configured to be in connection and communication with the smart terminal 300 or the cloud platform. The second wireless control module 220 is in wireless signal connection with the first wireless control module 120 of each irrigation device 100.

The second wireless control module 220 comprises a second control module and a second wireless communication module. The second control module may be implemented by an MCU or a CPU together with peripheral circuits thereof, and the second wireless communication module may be implemented by a Bluetooth chip, a Wi-Fi chip, an RF chip, or corresponding peripheral circuits thereof. The second housing 210 may further include a rechargeable battery for supplying power to the second wireless control module 220. Alternatively, a plug may be disposed on the second housing 210, and the plug can be connected to an external power source to allow the second wireless control module 220 to be powered by the external power source. Specifically, two second wireless communication modules are used. One of them is implemented by a Wi-Fi chip or a network port and is configured to be in connection and communication with the smart terminal 300 and the cloud platform. The other second wireless communication module is an RF chip, and is configured to connect each of the irrigation devices 100 in the network.

A second button 230 may be disposed on the second housing 210, and the second button 230 is electrically connected to the second wireless control module 220. When the second button 230 is operated by a user, the wireless network configuration mode of the gateway unit 200 is enabled or disabled. In the wireless network configuration mode, the gateway unit 200 enters a network configuration state and establishes a network configuration communication range. A network configuration request from any irrigation device 100 entering the network configuration communication range can be received by the gateway unit 200.

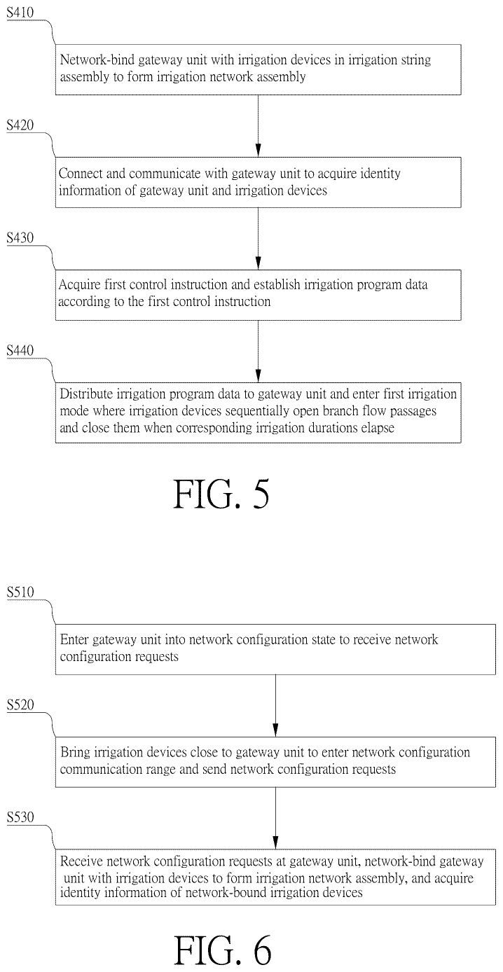

According to an embodiment of a third aspect of the present invention, a control method, as shown in FIG. 5, is disclosed as applicable to the irrigation control system as disclosed in any of the foregoing embodiments. The control method comprises:
S410. network-binding the gateway unit 200 with each of the irrigation devices 100 in the irrigation string assembly 160 so as to form at least a part of an irrigation network assembly;
S420. connecting and communicating with the gateway unit 200 to acquire identity information of the gateway unit 200 and the irrigation devices 100 in the irrigation network assembly;
S430. acquiring a first control instruction, and establishing irrigation program data corresponding to the irrigation network assembly in accordance with the first control instruction, wherein the irrigation program data include irrigation durations for the individual irrigation devices 100 and an irrigation sequence among the irrigation devices 100; and
S440. distributing the irrigation program data to the corresponding gateway unit 200, and entering the irrigation network assembly into a first irrigation mode, in which the irrigation devices 100 in the irrigation network assembly open the branch flow passages thereof sequentially according to the irrigation sequence and close the branch flow passages 112 when their corresponding irrigation durations elapse.

The gateway unit 200 may be disposed in any of plural irrigation regions. The single gateway unit 200 may be connected to all irrigation devices 100 in this irrigation region. The gateway unit 200 can acquire the respective identity information of each irrigation device 100 therewith and then upload the identity information of these irrigation devices 100 to the cloud platform. The user may establish respective irrigation strategies for the individual irrigation devices 100 in a targeted manner.

The user may establish irrigation program data corresponding to the irrigation network assembly through a first control instruction. The irrigation program data include respective irrigation durations of the irrigation devices 100 and the irrigation sequence among the irrigation devices 100. For example, the irrigation program data may be established that the individual irrigation devices 100 open their branch flow passages 112 one by one. Particularly, an upstream irrigation device 100 opens its branch flow passage 112 and maintains the open state until the irrigation duration elapses, at which point the branch flow passage 112 is closed, and then the immediate downstream irrigation device 100 opens its branch flow passage 112 and maintains the open state until the irrigation duration elapses, at which point the branch flow passage 112 is closed. After all the irrigation devices 100 complete irrigation, the process either stops or repeats the foregoing steps of the first irrigation mode. Alternatively, in the first irrigation mode, there may be multiple irrigation devices 100 making their branch flow passages 112 open at the same time. For example, the first irrigation device 100 opens its branch flow passage 112 first. After the branch flow passage 112 of the first irrigation device 100 is closed, the second irrigation device 100 and the third irrigation device 100 open their respective branch flow passages 112. Therein, according to their respective irrigation durations, the second irrigation device 100 and the third irrigation device 100 may close their branch flow passage 112 simultaneously or successively before the fourth irrigation device 100 opens its branch flow passage 112. Specifically, the irrigation strategy of the first irrigation mode is established according to the irrigation program data and is executed in an orderly manner.

According to the control method of the present invention, the gateway unit 200 and the respective irrigation devices 100 in the corresponding irrigation string assembly are network-bound to form an irrigation network assembly. A user can communicate with the gateway unit 200 through a smart terminal 300 to control each irrigation device 100 network-bound with the gateway unit 200. Since identity information of each irrigation device 100 is acquired, the user can, through a first control instruction, formulate the irrigation program data corresponding to the irrigation network assembly for each irrigation device 100, so as to control the irrigation devices 100 in the irrigation network assembly to sequentially open the branch flow passages 112 according to the irrigation sequence. Each irrigation device 100 closes its branch flow passage 112 when its respective irrigation duration elapses. By sequentially opening the branch flow passages 112 of the irrigation devices 100, a stable water pressure supply across different irrigation positions is ensured, and each irrigation device 100 is opened during its corresponding irrigation duration to supply water to its associated sprinkler component. This design features easy, simple layout and rational, orderly control, thereby ensuring desired irrigation quality.

In some embodiments of the present invention, the control method further comprises:
acquiring a second control instruction;
transmitting the second control instruction to the corresponding gateway unit 200, and entering the irrigation network assembly into a second irrigation mode, in which the irrigation devices 100 open or close the branch flow passages in accordance with the second control instruction.

The user may input a second control instruction via the smart terminal 300 to selectively control any of the irrigation devices 100, thereby opening or closing the corresponding branch flow passage 112 in real time to flexibly satisfy user requirements.

In some embodiments of the present invention, as shown in FIG. 6, the step of “network-binding the gateway unit 200 with each of the irrigation devices 100 in the irrigation string assembly 160 so as to form at least a part of an irrigation network assembly” comprises:
S510. entering the gateway unit 200 into a network configuration state so that the gateway unit 200 is capable of receiving network configuration requests;
S520. bringing the irrigation devices 100 close to the gateway unit to enter a network configuration communication range of the gateway unit 200, and sending the network configuration requests from the irrigation devices 100; and
S530. receiving the network configuration requests at the gateway unit 200 and network-binding the gateway unit 200 and the irrigation devices 100 so as to form the at least a part of the irrigation network assembly, and acquiring the identity information of the network-bound irrigation devices 100.

When network configuration is required, the user presses the second button 230 of the gateway device 200 while simultaneously pressing the first buttons 150 of the irrigation devices 100 to be networked. The irrigation devices 100 are then sequentially brought close to the gateway device 200 to enter a network configuration communication range of the gateway device 200, thereby enabling the network configuration requests transmitted from the irrigation devices 100 to be received by the gateway device 200. After an irrigation network assembly is established, the gateway device 200 acquires identity information of the irrigation devices 100 that have been network-bound, so that control instructions corresponding to the respective irrigation devices 100 can be matched with their identity information and transmitted by the gateway device 200 to the corresponding irrigation devices 100 for execution.

In some embodiments of the present invention, after the step of “establishing irrigation schedule data corresponding to the irrigation network assembly in accordance with the first control instruction,” the control method comprises the following steps:
generating an irrigation program table based on the irrigation durations respectively corresponding to the irrigation devices 100 and based on sequential irrigation processing of the irrigation devices 100;
for any irrigation device 100 whose branch flow passage 112 is currently open, acquiring an elapsed opening duration of the irrigation device 100 and calculating a remaining opening duration according to the irrigation duration and the elapsed opening duration; and
updating the irrigation program table with the remaining opening duration.

The irrigation program table may be displayed on the display interfaces of the smart terminal 300 and the cloud platform. The irrigation program table presents the networking status of each irrigation device 100 and displays the irrigation sequence, irrigation durations, and irrigation statuses of the respective irrigation devices 100. In addition, a remaining opening duration is calculated based on the elapsed opening duration and the irrigation duration of the irrigation device 100 that has its branch flow passage 112 currently open, and the irrigation program table is continuously updated using the remaining opening duration. Accordingly, the user may view, in real time, the remaining opening duration of the irrigation device 100 that has its branch flow passage 112 currently open, thereby allowing flexible control.

In some embodiments of the present invention, the control method further comprises:
acquiring a third control instruction, which enables selection of at least one of the irrigation devices 100 for a positioning display step; and
in the positioning display step, outputting indication information from the selected irrigation device 100.

Each irrigation device 100 may further be provided with an indication module 180 on the first housing 110. The first wireless control module 120 is electrically connected to the indication module 180, which may include an indicator light or a buzzer. A user may click an icon corresponding to one of the irrigation devices 100 on the smart terminal 300 to generate a third control instruction. The third control instruction is transmitted to the gateway device 200, which in turn transmits the third control instruction to cause the indication module 180 of the selected irrigation device 100 to output indication information, for example, by having the indicator light emit flashing green light.

In some embodiments of the present invention, there are plural irrigation network assemblies. The smart terminal 300 is in connection and communication with the gateway units 200 in the irrigation network assemblies. The smart terminal 300 is configured to distribute the irrigation program data to the gateway unit 200 of one irrigation network assembly and to the gateway unit 200 of another irrigation network assembly at a time interval defined by a preset time value.

When the smart terminal 300 performs control of the irrigation devices 100 across multiple irrigation network assemblies, data need to be transmitted to the multiple irrigation network assemblies. To avoid excessive interference in wireless signal transmission, the smart terminal 300 transmits the data with time intervals therebetween. Specifically, the smart terminal 300 first transmits data to the gateway device 200 of one irrigation network assembly and then, after a preset time interval, transmits data to the gateway device 200 of another irrigation network assembly. The preset time interval may be, for example, one second, two seconds, or the like, as determined by design personnel.

The disclosed control method may be executed by a smart terminal, a cloud platform, a gateway unit, or a control device disposed in the irrigation device. The control device comprises a memory and a processor. The memory stores a computer program which, when being executed by the processor, performs the control method disclosed in any of the foregoing embodiments.

The control device may be implemented as any smart terminal, including, for example, a central computer or a remote terminal device.

Specifically, the control device may include:
a processor, which may be implemented by a general-purpose central processing unit (CPU), a microprocessor, an application specific integrated circuit (ASIC), or one or more integrated circuits, and is configured to execute relevant programs to implement the technical solutions provided in the embodiments of the present application;
a memory, which may be implemented by a read only memory (ROM), a static storage device, a dynamic storage device, or a random access memory (RAM), and is configured to store an operating system and other application programs, so that when the technical solutions of the embodiments of the present application are implemented by software or firmware, relevant program codes are stored in the memory and executed by the processor to perform the control method of the embodiments of the present application;
an input/output (i/o) interface, which is configured to perform information input and output; and
a communication interface, which is configured to enable communication and data interaction between the disclosed device and other devices, wherein the communication may be implemented wirelessly, for example, via a mobile network, Wi-Fi, Bluetooth, or other wireless communication technologies.

In addition, the present application further provides a computer-readable storage medium. The computer-readable storage medium stores a computer program which, when being executed by a processor, is configured to perform the control method disclosed in any of the foregoing embodiments.

The memory, as a non-transitory computer-readable storage medium, is adapted to store non-transitory software programs and computer-executable instructions. The memory may include a high-speed random access memory and may further include non-transitory memories such as at least one magnetic disk storage component, a flash memory device, or other non-transitory solid-state storage components. In some embodiments, the memory optionally includes a memory remote to the processor. The remote storage is connectable to the processor via a network. Examples of the network include, but are not limited to, the Internet, an intranet, a local area network, a mobile communication network, and any combination thereof.

1. An irrigation device, comprising:
a first housing, defining a main flow passage and a branch flow passage therein, the first housing being provided with an inlet port, a first outlet port, and a second outlet port, the inlet port being in fluid communication with an upstream end of the main flow passage, the first outlet port being in fluid communication with a downstream end of the main flow passage, the branch flow passage having an upstream end being in fluid communication with the main flow passage, and the second outlet port being in fluid communication with a downstream end of the branch flow passage;
a first wireless control module, disposed in the first housing; and
a valve unit, disposed in the first housing and partially located in the branch flow passage, wherein the first wireless control module is connected to and controls the valve unit to open or close the branch flow passage.

2. The irrigation device of claim 1, further comprising a timer module, which is connected to and provides the first wireless control module with timing signals so that the first wireless control module controls the valve unit to open or close the branch flow passage in accordance with the timing signals.

3. An irrigation control system, comprising a gateway unit and a plurality of irrigation devices as described in claim 1, wherein the gateway unit is in wireless connection with the irrigation devices, respectively, and the irrigation devices are connected in series by a water tube to form at least a part of an irrigation string assembly, so that in the irrigation string assembly, between two adjacent said irrigation devices, the first outlet port of the upstream irrigation device is in fluid communication with the inlet port of the downstream irrigation device through the water tube.

4. The irrigation control system of claim 3, wherein the gateway unit comprises a second housing and a second wireless control module disposed in the second housing, in which the second wireless control module is configured to be in connection and communication with a smart terminal or a cloud platform, and to be in wireless signal connection with the first wireless control module of each of the irrigation devices.

5. A control method being applicable to an irrigation control system as described in claim 3, the control method comprising:
network-binding the gateway unit with each of the irrigation devices in the irrigation string assembly so as to form at least a part of an irrigation network assembly;
connecting and communicating with the gateway unit to acquire identity information of the gateway unit and the irrigation devices in the irrigation network assembly;
acquiring a first control instruction, and establishing irrigation program data corresponding to the irrigation network assembly in accordance with the first control instruction, wherein the irrigation program data include irrigation durations for the individual irrigation devices and an irrigation sequence among the irrigation devices; and
distributing the irrigation program data to the corresponding gateway unit, and entering the irrigation network assembly into a first irrigation mode, in which the irrigation devices in the irrigation network assembly open the branch flow passages thereof sequentially according to the irrigation sequence and close the branch flow passages when their corresponding irrigation durations elapse.

6. The control method of claim 5, further comprising: acquiring a second control instruction; and
transmitting the second control instruction to the corresponding gateway unit, and entering the irrigation network assembly into a second irrigation mode, in which the irrigation devices open or close the branch flow passages in accordance with the second control instruction.

7. The control method of claim 5, wherein the step of “network-binding the gateway unit with each of the irrigation devices in the irrigation string assembly so as to form at least a part of an irrigation network assembly” further comprises:
entering the gateway unit into a network configuration state so that the gateway unit is capable of receiving network configuration requests;
bringing the irrigation devices close to the gateway unit to enter a network configuration communication range of the gateway unit, and sending the network configuration requests from the irrigation devices; and
receiving the network configuration requests at the gateway unit and network-binding the gateway unit and the irrigation devices so as to form at least said part of the irrigation network assembly, and acquiring the identity information of the network-bound irrigation devices.

8. The control method of claim 5, further comprising, after the step of “establishing irrigation program data corresponding to the irrigation network assembly in accordance with the first control instruction,” steps of:
generating an irrigation program table based on the irrigation durations respectively corresponding to the irrigation devices and based on sequential irrigation processing of the irrigation devices;
for any said irrigation device whose branch flow passage is currently open, acquiring an elapsed opening duration of the irrigation device and calculating a remaining opening duration according to the irrigation duration and the elapsed opening duration; and
updating the irrigation program table with the remaining opening duration.

9. The control method of claim 5, further comprising: acquiring a third control instruction, which enables selection of at least one of the irrigation devices for a positioning display step; and
in the positioning display step, outputting indication information from the selected irrigation device.

10. The control method of claim 5, wherein plural said irrigation network assemblies are included, and a smart terminal is in connection and communication with the gateway units in the irrigation network assemblies, in which the smart terminal is configured to distribute the irrigation program data to the gateway unit of one said irrigation network assembly and to the gateway unit of another said irrigation network assembly at a time interval defined by a preset time value.
